(19) United States
(12) Patent Application Publication
(10) Pub. No.: US 2026/0127989 A1
(43) Pub. Date: May 7, 2026

(54) DISPLAY DEVICE AND ANALYSIS METHOD

(71) Applicants: SONY SEMICONDUCTOR SOLUTIONS CORPORATION, Kanagawa (JP); SONY GROUP CORPORATION, Tokyo (JP)

(72) Inventors: Takashi TOYODA, Kanagawa (JP); Haruki TSUCHIYA, Kanagawa (JP)

(73) Assignees: SONY SEMICONDUCTOR SOLUTIONS CORPORATION, Kanagawa (JP); SONY GROUP CORPORATION, Tokyo (JP)

(21) Appl. No.: 19/105,105

(22) PCT Filed: Aug. 21, 2023
(86) PCT No.: PCT/JP2023/030033

§ 371 Date: Feb. 20, 2025

(30) Foreign Application Priority Data
Aug. 30, 2022 (JP) 2022-137096

(51) Int. Cl. G09G 3/00; G09G 3/3233; G09G 3/3291

(52) U.S. Cl. CPC G09G 3/006; G09G 3/3291; G09G 3/3233; G09G 2300/0413; G09G 2380/10

(57) ABSTRACT

A display device includes: a pixel array including a plurality of pixels; a control unit including a plurality of output terminals that outputs video signals; a plurality of selectors provided between the pixel array and the control unit, each selector electrically connecting or electrically disconnecting a corresponding output terminal of the control unit and a corresponding pixel of the pixel array to or from each other; and a plurality of paths connected to the output terminals corresponding to one ends of the respective paths, in which the plurality of paths includes: a plurality of connection paths connected to the selectors corresponding to another ends of the respective paths; and a dummy path not connected to the selectors corresponding to another ends of the respective path.

### FIELD

The present disclosure relates to a display device and an analysis method.

### BACKGROUND

For example, a display device of Patent Literature 1 includes a display panel provided with a pixel array including an organic light emitting diode (OLED) as a light emitting element.

### CITATION LIST

### Patent Literature

Patent Literature 1: WO 2016/072139 A

### SUMMARY

### Technical Problem

A control unit such as a display driver IC (DDIC) may be provided on a display panel. An output terminal of the control unit is connected to a corresponding pixel in a pixel array via a selector provided on the display panel. There is a possibility that a defect occurs in a path between the output terminal of the control unit and the selector. It is useful for defect analysis and the like if a defective portion of the path can be specified.

One aspect of the present disclosure specifies the defective portion of the path between the output terminal of the control unit and the selector.

### Solution to Problem

A display device according to one aspect of the present disclosure includes: a pixel array including a plurality of pixels; a control unit including a plurality of output terminals that outputs video signals; a plurality of selectors provided between the pixel array and the control unit, each selector electrically connecting or electrically disconnecting a corresponding output terminal of the control unit and a corresponding pixel of the pixel array to or from each other; and a plurality of paths connected to the output terminals corresponding to one ends of the respective paths, wherein the plurality of paths includes: a plurality of connection paths connected to the selectors corresponding to another ends of the respective paths; and a dummy path not connected to the selectors corresponding to another ends of the respective path.

An analysis method according to one aspect of the present disclosure is a method for a display device, the display device including: a pixel array including a plurality of pixels; a control unit including a plurality of output terminals that outputs video signals; a plurality of selectors provided between the pixel array and the control unit, each selector electrically connecting or electrically disconnecting a corresponding output terminal of the control unit and a corresponding pixel of the pixel array to or from each other; and a plurality of paths connected to the output terminals corresponding to one ends of the respective paths, the plurality of paths including: a plurality of connection paths connected to the selectors corresponding to another ends of the respective paths; and a dummy path not connected to the selectors corresponding to another ends of the respective path, the analysis method comprising: for each of the plurality of paths, in a case where it is assumed that current loads of the respective output terminals are equal to each other, outputting the video signals such that a current of a corresponding one of the output terminals is larger than a current of another of the output terminals, and measuring a consumption current of the control unit; and specifying a defective portion of at least one connection path among the plurality of connection paths on a basis of a result of the measuring.

### BRIEF DESCRIPTION OF DRAWINGS

FIG. 1 is a diagram illustrating an example of a schematic configuration of a display device 1 according to an embodiment.

FIG. 2 is a diagram illustrating an example of a schematic configuration of a selector 51.

FIG. 3 is a diagram illustrating an example of a schematic configuration of a plurality of paths P.

FIG. 4 is a diagram illustrating an example of a schematic configuration of a connection path CP.

FIG. 5 is a diagram illustrating the example of the schematic configuration of the connection path CP.

FIG. 6 is a diagram illustrating an example of a schematic configuration of a dummy path DP.

FIG. 7 is a diagram illustrating an example of the schematic configuration of the dummy path DP.

FIG. 8 is a diagram illustrating an example of the schematic configuration of the dummy path DP.

FIG. 9 is a diagram illustrating an example of the schematic configuration of the dummy path DP.

FIG. 10 is a diagram illustrating an example of specifying a disconnection portion.

FIG. 11 is a diagram illustrating an example of a consumption current I for each path P.

FIG. 12 is a flowchart illustrating an example of an analysis method.

FIG. 13 is a diagram illustrating a modification.

FIG. 14 is a diagram illustrating a modification.

FIG. 15 is a diagram illustrating a modification.

FIG. 16 is a diagram illustrating a configuration example of a pixel PIX.

FIG. 17 is a diagram illustrating another configuration example of the pixel PIX.

FIG. 18 is a diagram illustrating another configuration example of the pixel PIX.

FIG. 19 is a diagram illustrating another configuration example of the pixel PIX.

FIG. 20 is a diagram illustrating another configuration example of the pixel PIX.

FIG. 21 is a diagram illustrating another configuration example of the pixel PIX.

FIG. 22 is a diagram illustrating another configuration example of the pixel PIX.

FIG. 23 is a diagram illustrating another configuration example of the pixel PIX.

FIG. 24 is a diagram illustrating an example of an external appearance of a head mounted display 110.

FIG. 25 is a diagram illustrating an example of an external appearance of another head mounted display 120.

FIG. 26 is a diagram illustrating an example of an external appearance of a digital still camera 130.

FIG. 27 is a diagram illustrating an example of the appearance of the digital still camera 130.

FIG. 28 is a diagram illustrating an example of an external appearance of a television device 140.

FIG. 29 is a diagram illustrating an example of an external appearance of a smartphone 150.

FIG. 30 is a diagram illustrating a configuration example of a vehicle to which the technology of the present disclosure is applied.

FIG. 31 is a diagram illustrating the configuration example of the vehicle to which the technology of the present disclosure is applied.

### DESCRIPTION OF EMBODIMENTS

Hereinafter, embodiments of the present disclosure will be described in detail with reference to the drawings. Note that, in each of the following embodiments, the same elements are denoted by the same reference numerals, and redundant description will be omitted.

The present disclosure will be described in accordance with the following order of items.
1. Embodiment
2. Modification
3. Examples of effects
4. Examples of pixel circuits
5. Examples of use cases

### 1. Embodiment

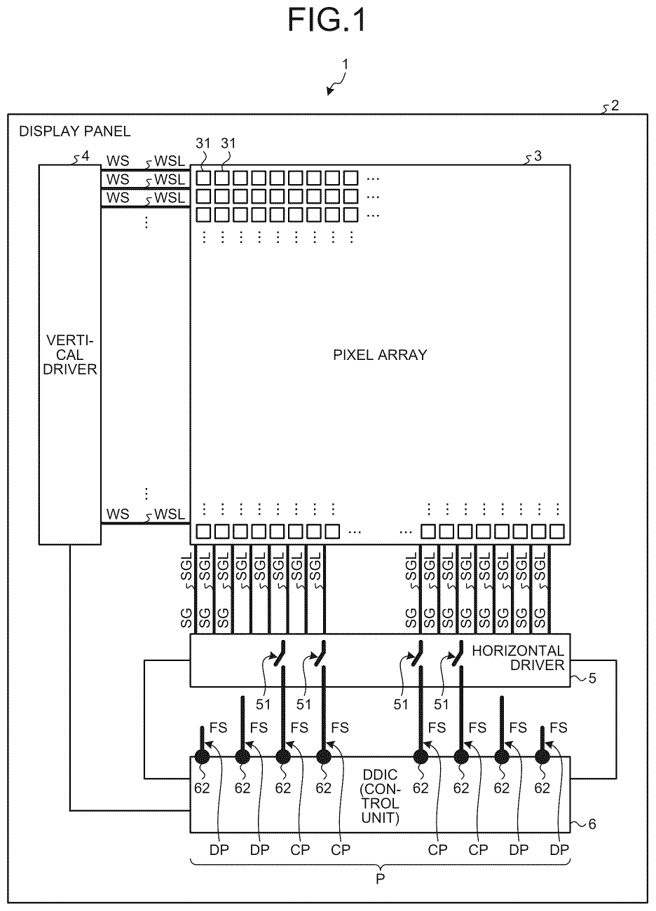

FIG. 1 is a diagram illustrating an example of a schematic configuration of a display device 1 according to an embodiment. The display device 1 includes a display panel 2, a pixel array 3, a vertical driver 4, a horizontal driver 5, a DDIC 6, and a plurality of paths P.

The display panel 2 is provided with the pixel array 3, the vertical driver 4, the horizontal driver 5, the DDIC 6, and the plurality of paths P. The pixel array 3, the vertical driver 4, the horizontal driver 5, and the plurality of paths P are formed in the display panel 2 by a semiconductor process or the like, for example. The DDIC 6 is an example of a control unit in the display device 1, and, for example, is manufactured separately from the display panel 2 and mounted on the display panel 2. A circuit or the like having a function similar to that of the DDIC 6 may be directly formed on the display panel 2 as the control unit. The DDIC 6 and the control unit may be read interchangeably as appropriate as long as there is no contradiction. Note that arrangement of the elements in the display panel 2 is not limited to the example illustrated in FIG. 1.

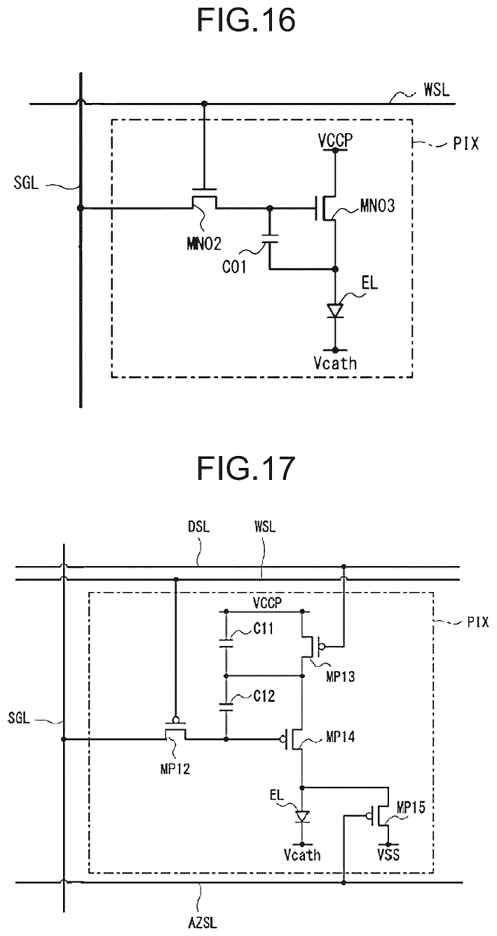

The pixel array 3 includes a plurality of pixels 31. The plurality of pixels 31 is arranged two-dimensionally in the horizontal direction and the vertical direction. One pixel 31 may be a sub-pixel that emits one of red light (R), green light (G), and blue light (B). Each pixel 31 includes, for example, a light emitting element, a transistor, a capacitor (capacitor), and the like. An example of the light emitting element is an OLED. Various known pixel configurations may be employed, and some specific examples will be described later with reference to FIGS. 16 to 23.

The vertical driver 4 selects and drives the pixels 31 corresponding to a display line in the horizontal direction. The vertical driver 4 is connected to the pixel array 3 via a plurality of control lines WSL. For example, one control line WSL is connected to each of the pixels 31 arranged in the horizontal direction. The vertical driver 4 selects a control line WSL and supplies a control signal WS for controlling light emission and non-light-emission of the corresponding pixels 31 to the selected control line WSL.

Note that “connected” may be understood to mean “electrically connected” as long as there is no contradiction. “Electrically connected” may be understood to include an aspect in which another element is interposed between elements to be connected to each other as long as functions of the elements to be connected to each other is not hindered.

The horizontal driver 5 selects and drives the pixels 31 corresponding to a display line in the vertical direction. The horizontal driver 5 is connected to the pixel array 3 via a plurality of signal lines SGL. For example, one signal line SGL is connected to each of the pixels 31 arranged in the vertical direction. The horizontal driver 5 selects a signal line SGL and supplies a pixel signal SG for controlling an amount of light emission (luminance or the like) of the corresponding pixels 31 to the selected signal line SGL.

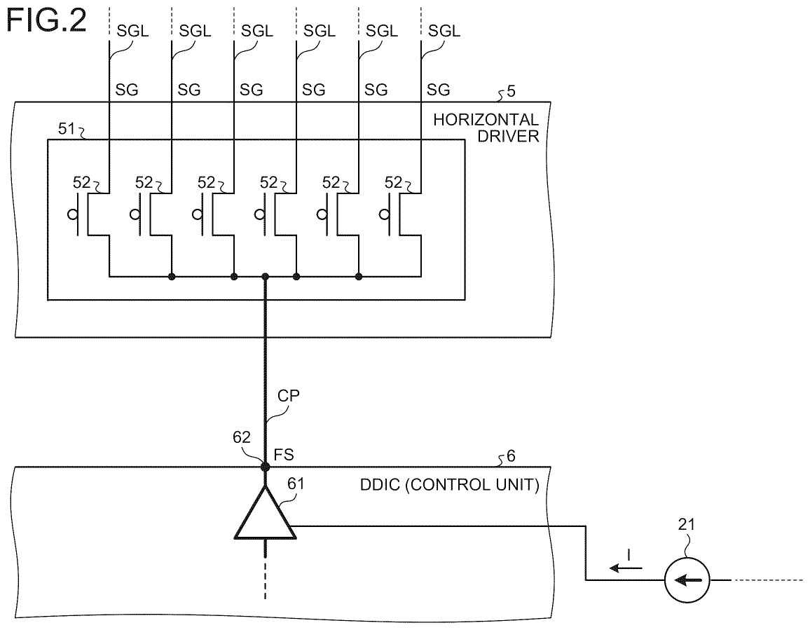

The horizontal driver 5 includes a plurality of selectors 51 provided between the pixel array 3 and the DDIC 6. Each selector 51 connects or disconnects a corresponding output terminal 62 of the DDIC 6 and the corresponding pixels 31 of the pixel array 3 to or from each other. Further details of the selector 51 will be described later with reference to FIG. 2.

The DDIC 6 is a display driver integrated circuit (IC) that drives the display device 1. The DDIC 6 is connected to each of the vertical driver 4 and the horizontal driver 5.

The DDIC 6 supplies a control signal for controlling selection and the like of the pixels 31 by the vertical driver 4 to the vertical driver 4. The vertical driver 4 supplies the control signal WS to each pixel 31 on the basis of the control signal from the DDIC 6.

The DDIC 6 supplies a control signal for controlling selection and the like of the pixels 31 by the horizontal driver 5 to the horizontal driver 5. The horizontal driver 5 selects the pixels 31 corresponding to the display line in the vertical direction on the basis of the control signal from the DDIC 6.

Furthermore, the DDIC 6 supplies a video signal FS to the horizontal driver 5. Specifically, the DDIC 6 includes a plurality of output terminals 62 capable of outputting the video signals FS. The video signal FS from each output terminal 62 is supplied to the horizontal driver 5. The horizontal driver 5 supplies the video signal FS from the DDIC 6 to the selected pixels 31 via a corresponding signal line SGL. The video signal FS supplied to the pixels 31 via the signal line SGL is referred to as the pixel signal SG and illustrated. The pixel signal SG is a voltage signal (for example, a pulse voltage) that charges capacitors in the pixels 31. A current for this charging is supplied from the output terminal 62 of the DDIC 6.

The plurality of paths P includes a plurality of connection paths CP and one or more dummy paths DP. The connection path CP among the connection path CP and the dummy paths DP connects the output terminal 62 of the DDIC 6 and the selector 51 to each other. That is, the selector 51 is connected to the output terminal 62 of the DDIC 6 via the connection path CP. A description will be given also with reference to FIG. 2.

FIG. 2 is a diagram illustrating an example of a schematic configuration of the selector 51. One selector 51 and its peripheral portion are schematically illustrated. In this example, the selector 51 is a demultiplexer configured to receive as an input one video signal FS and output a plurality of pixel signals SG. The selector 51 includes a plurality of switches 52 that can be individually subjected to on-off control. The plurality of switches 52 is, for example, field effect transistors (FETs) connected in parallel.

One end of each switch 52 is connected to the same connection path CP. The other end of each switch 52 is connected to a signal line SGL directed to the corresponding pixels 31 (FIG. 1). In the example illustrated in FIG. 2, one selector 51 includes six switches 52, and corresponding six signal lines SGL are connected to the pixels 31 constituting two display lines.

The DDIC 6 includes an amplifier 61 corresponding to the selector 51. An output end of the amplifier 61 is connected to the output terminal 62. The video signal FS is output via the amplifier 61 and the output terminal 62. The amplifier 61 operates using a voltage and a current (power) from a power supply 21 provided in the display panel 2 (FIG. 1). Although not illustrated, the power supply 21 is also connected to another portion of the DDIC 6, for example, an amplifier different from the illustrated amplifier 61, and supplies power consumption of the DDIC 6. The current flowing from the power supply 21 to the DDIC 6 is referred to as a consumption current I of the DDIC 6 and illustrated.

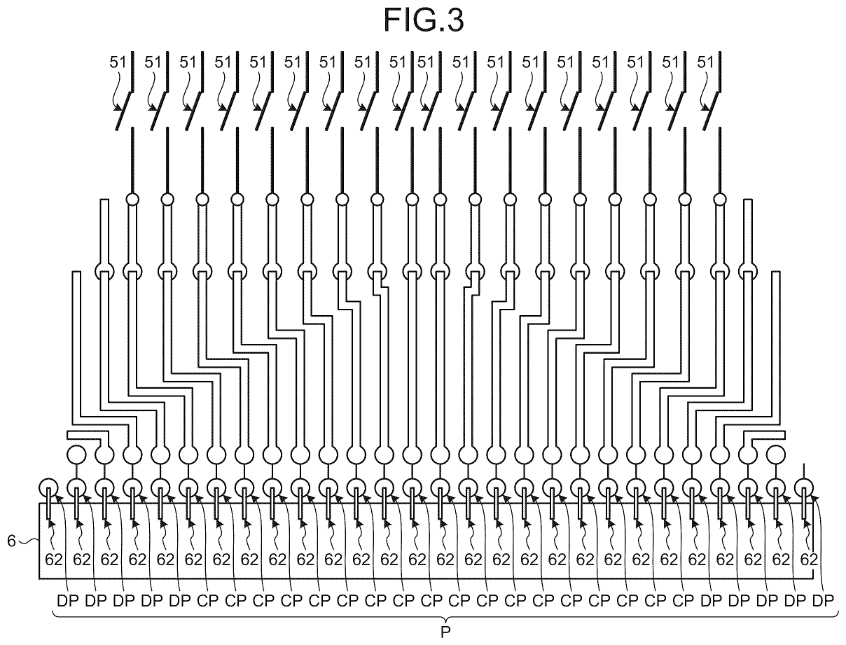

For example, the selector 51 as described above is connected to the corresponding output terminal 62 of the DDIC 6 via the connection paths CP. The plurality of paths P including the connection paths CP and the dummy paths DP will be described with reference to FIG. 3.

FIG. 3 is a diagram illustrating an example of a schematic configuration of the plurality of paths P. In this example, the plurality of paths P includes a plurality of connection paths CP and a plurality of dummy paths DP. One ends of each connection path CP and each dummy path DP are connected to corresponding output terminals 62 of the DDIC 6.

The other end of the connection path CP is connected to a corresponding selector 51 of the horizontal driver 5. The connection path CP is connected between the output terminal 62 and the selector 51, and supplies the video signal FS from the output terminal 62 to the selector 51.

The other end of the dummy path DP is not connected to any selector 51. The dummy path DP is designed so that a current load of the output terminal 62 of the DDIC 6 to which the dummy path DP is connected is smaller than a current load of the output terminal 62 to which the connection path CP is connected. The larger the current load, the larger a current of the output terminal 62 when the same video signal FS is output. It can also be said that the larger the current load, the larger a capacitance when the path P is viewed from the output terminal 62.

In the example illustrated in FIG. 3, the plurality of paths P includes a plurality of dummy paths DP having lengths different from each other. Each dummy path DP is shorter than the connection path CP, and the other end of the dummy path DP is opened. The shorter the dummy path DP, the smaller the current load of the output terminal 62 due to the fact that a wiring capacitance of the dummy path DP decrease, and the like.

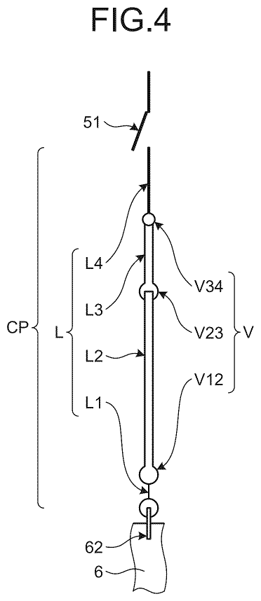

Examples of specific configurations of the connection path CP and the dummy path DP will be described with reference to FIGS. 4 to 9.

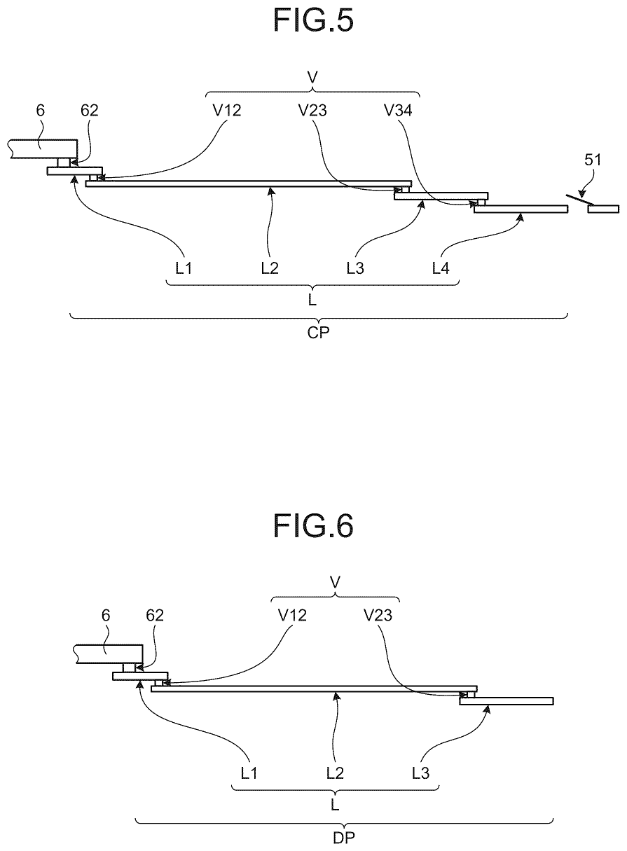

FIGS. 4 and 5 are diagrams illustrating an example of a schematic configuration of the connection path CP. FIG. 4 schematically illustrates a plane layout of the connection path CP. FIG. 5 schematically illustrates a side layout of the connection path CP.

The connection path CP includes a plurality of wiring lines L and one or more vias V. The plurality of wiring lines L is connected in series between the output terminal 62 of the DDIC 6 and the selector 51. Adjacent wiring lines L among the plurality of wiring lines L are connected to each other via the via V to extend in different wiring layers. The wiring layers are, for example, wiring layers of a multilayer substrate constituting the display panel 2.

Specifically, in FIGS. 4 and 5, a wiring line L1, a wiring line L2, a wiring line L3, and a wiring line L4 are exemplified as the wiring lines L. As the vias V, a via V12, a via V23, and a via V34 are exemplified. The wiring line L1, the via V12, the wiring line L2, the via V23, the wiring line L3, the via V34, and the wiring line L4 are connected to each other in this order from the output terminal 62 of the DDIC 6 toward the selector 51.

For example, the wiring line L1 is provided on a surface layer of the display panel 2 on which the DDIC 6 is mounted. The wiring line L2, the wiring line L3, and the wiring line L4 are provided on inner layers of the display panel 2. The via V12 connects the wiring line L1 and the wiring line L2 to each other. The via V23 connects the wiring line L2 and the wiring line L3 to each other. The via V34 connects the wiring line L3 and the wiring line L4 to each other.

FIGS. 6 to 9 are diagrams illustrating examples of a schematic configuration of the dummy path DP. Side layouts of the dummy paths DP having different lengths are schematically illustrated. In the examples, the dummy path DP includes a smaller number of wiring lines L than the plurality of wiring lines L of the connection path CP. A wiring line L located closest to the selector 51 in the dummy path DP may be shorter than a corresponding wiring line L of the connection path CP.

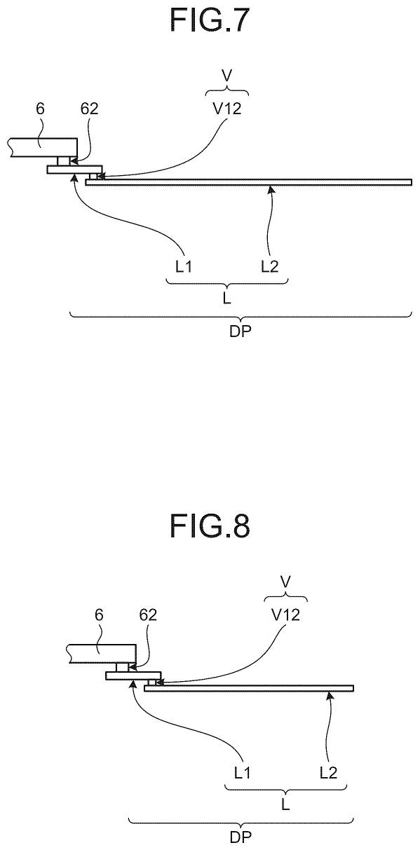

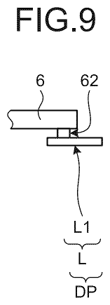

Specifically, in the example exemplified in FIG. 6, the dummy path DP is different from the connection path CP (FIG. 5) in that the wiring line L4 and the via V34 are not included. In the example illustrated in FIG. 7, the dummy path DP does not include the wiring line L3 or the via V23. In the example illustrated in FIG. 8, the wiring line L located closest to the selector 51 in the dummy path DP is the wiring line L2, and the wiring line L2 is shorter than the wiring line L2 (FIG. 5) of the connection path CP. In the example illustrated in FIG. 9, the dummy path DP does not include the wiring line L2 or the via V12.

According to the display device 1 having the configuration described above, even in a case where a defect occurs in any connection path CP among the plurality of connection paths CP, the connection path CP in which the defect has occurred and a defective portion thereof can be specified. Hereinafter, a description will be given assuming that the defect is a disconnection.

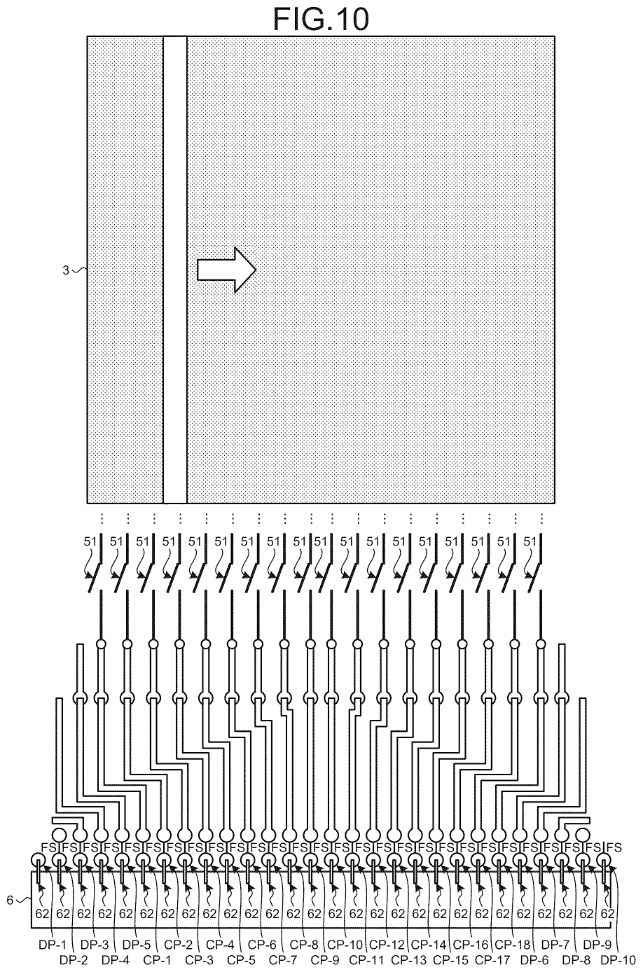

FIG. 10 is a diagram illustrating an example of specifying a disconnection portion. The plurality of connection paths CP is respectively referred to as a connection path CP-1 to a connection path CP18 and illustrated, to be distinguishable from each other. The dummy paths DP are respectively referred to as a dummy path DP-1 to a dummy path DP-10 and illustrated, to be distinguishable from each other.

First, in a case where it is assumed that current loads of the output terminals 62 are the same as each other, the video signals FS are output so that a current of one output terminal 62 is larger than currents of other output terminals 62. For example, the output terminals 62 of the DDIC 6 outputs the video signals FS so that only (the pixels 31 of) the display line of the pixel array 3 corresponding to the connection path CP of the one output terminal 62 emits white light. In this state, the consumption current I (FIG. 2) of the DDIC 6 is measured.

Next, the video signals FS are output so that a current of another output terminal 62 is larger than currents of other output terminals 62, and the consumption current I of the DDIC 6 is measured. Similar measurements are performed across all the output terminals 62. That is, the consumption current I of the DDIC 6 is measured for each of the plurality of paths P corresponding to the plurality of output terminals 62.

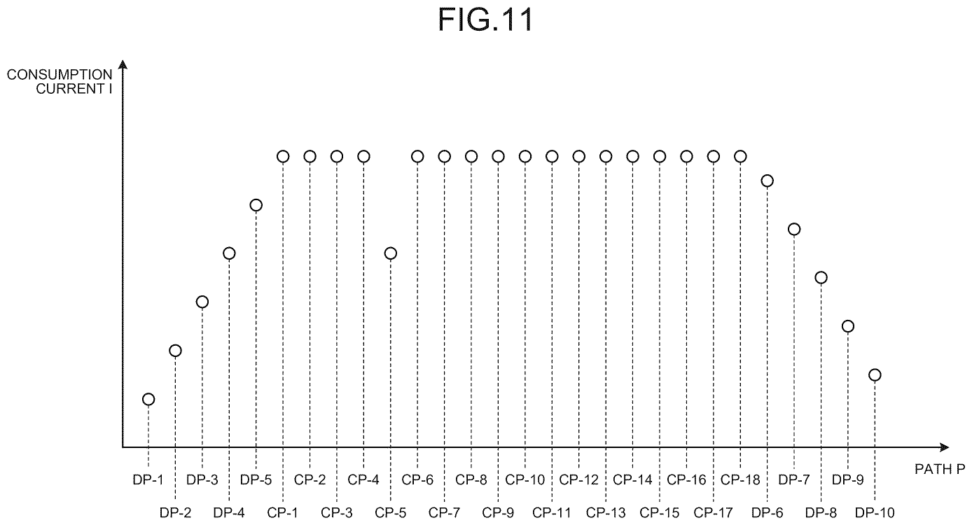

FIG. 11 is a diagram illustrating an example of the consumption current I for each path P. The horizontal axis of the graph indicates the path P. The vertical axis of the graph indicates a magnitude of the consumption current I. The magnitude of the consumption current I of each path P is indicated by a circle plot.

Regarding the connection path CP, in this example, among the connection path CP-1 to the connection path CP-18, only the consumption current I of the connection path CP-5 is small. That is, among the plurality of output terminals 62 to which the connection path CP-1 to the connection path CP-18 are connected, only the current load of the output terminal 62 to which the connection path CP-5 is connected is small. This means that a capacitance when the connection path CP-5 is viewed from the output terminal 62 is small, that is, the connection path CP-5 is opened in the middle. Thus, it can be specified that a disconnection has occurred in the connection path CP-5.

Regarding the dummy path DP, the consumption currents I of the dummy path DP-1 to the dummy path DP-10 are smaller than the consumption currents I of the connection path CP-1 to the connection path CP-4 and the connection path CP-6 to the connection path CP-10 in which no disconnection has occurred. Furthermore, the magnitude of the consumption current I is different for each dummy path DP.

Here, it should be noted that the magnitude of the consumption current I of the connection path CP-5 is close to the magnitude of the consumption current I of the dummy path DP-4. From this, it can be estimated that the connection path CP-5 is disconnected like the dummy path DP-4. That is, it can be estimated that a disconnection has occurred at a position of the connection path CP-5 corresponding to the other end (open end) of the dummy path DP-4. Thus, the position can be specified as a disconnection portion of the connection path CP-5.

For example, as described above, it is possible to specify a connection path CP in which the disconnection has occurred among the plurality of connection paths CP, and further to specify the disconnection portion of the connection path CP.

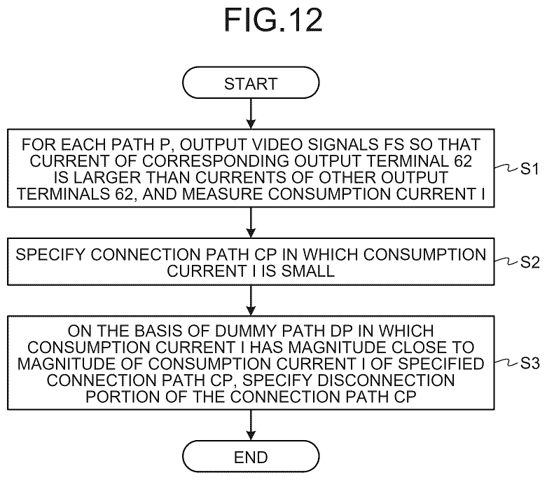

FIG. 12 is a flowchart illustrating an example of an analysis method. This analysis method is used, for example, at the time of trial production of the display device 1, at the time of analysis of a returned product, and the like. Details of each step have been described above, so detailed description will not be repeated.

In step S1, for each path P, the video signals FS are output so that a current of a corresponding output terminal 62 is larger than currents of other output terminals 62. At the same time, the consumption current I of the DDIC 6 is measured. For example, the video signals FS as described above with reference to FIG. 10 are output from the respective output terminal 62 of the DDIC 6.

In step S2, a connection path CP is specified in which the consumption current I is small. For example, as described above with reference to FIG. 11, among the plurality of connection paths CP, a connection path CP is specified in which the consumption current I is smaller than those of other connection paths CP.

In step S3, on the basis of the dummy path DP in which the consumption current I has a magnitude close to a magnitude of the consumption current I of the specified connection path CP, a disconnection portion of the connection path CP is specified. For example, as described above with reference to FIG. 11, a position of the connection path CP corresponding to the open end of the dummy path DP is specified as the disconnection portion.

For example, as described above, it is possible to specify the connection path CP in which the disconnection has occurred among the plurality of connection paths CP, and further to specify the disconnection portion. Specifying the disconnection portion can be used for subsequent defect analysis or the like. For example, the disconnection portion is narrowed down, whereby work such as defect analysis can be efficiently performed.

Note that the DDIC 6 may be designed to facilitate the analysis method described above. For example, the DDIC 6 may be designed to be switched to a dedicated mode (analysis mode) in which the video signal FS corresponding to each path P is output at high speed in step S1 described above. In such an analysis mode, power consumption other than the output of the video signal FS may be suppressed so that the magnitude of the current of each output terminal 62 of the DDIC 6 is easily reflected in the magnitude of the consumption current I of the DDIC 6.

### 2. Modification

The configuration of the plurality of paths P including the dummy path DP is not limited to the embodiment described above. Some modifications will be described.

FIGS. 13 to 15 are diagrams illustrating modifications. In the example illustrated in FIG. 13, the connection path CP is also a dummy path DP. In the example illustrated in (A) of FIG. 13, any of the plurality of connection paths CP also functions as the dummy path DP. As illustrated in (B) of FIG. 13, the connection path CP includes switches SW connected in series in the connection path CP. As the switches SW, a switch SW1, a switch SW2, and a switch SW3 are exemplified. By turning any of the switches SW off (non-conductive state), it is possible to cause the connection path CP to function as a dummy path DP shorter than the connection path CP. The number of paths P can be reduced.

Note that only some connection paths CP among the plurality of connection paths CP may have the configuration as illustrated in (B) of FIG. 13 and be used as dummy paths DP.

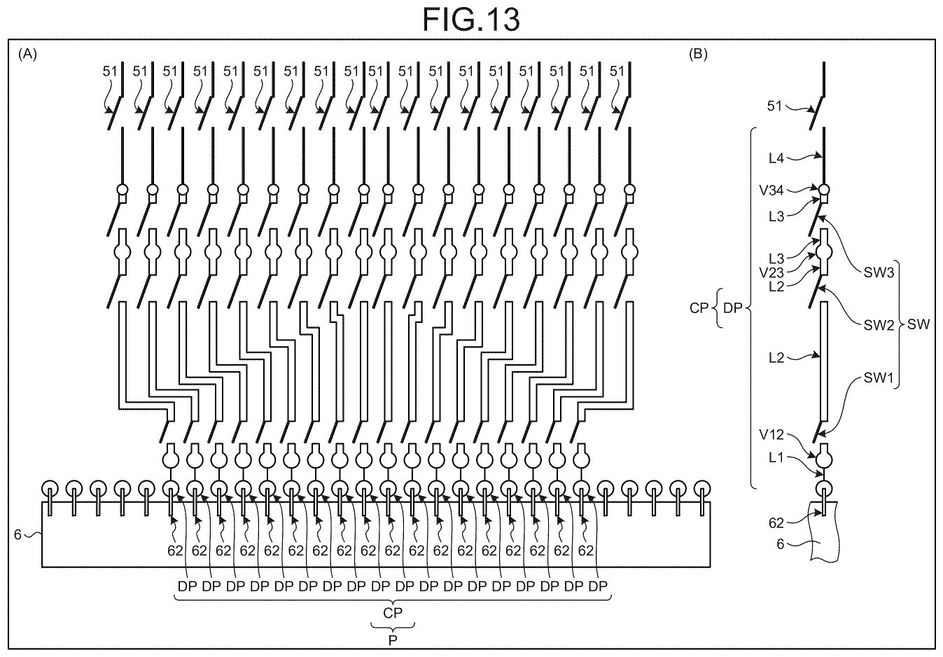

In the example illustrated in FIG. 14, the dummy path DP includes switches SW connected in series in the dummy path DP. As the switches SW, the switch SW1, the switch SW2, and the switch SW3 are exemplified. By turning off the switch SW, it is possible to make a corresponding position in the dummy path DP opened. The length of the dummy path DP connected to the output terminal 62 can be changed by a combination of on/off of the switched SW. That is, it is possible to cause one dummy path DP to function as a plurality of dummy paths DP having lengths different from each other. Accordingly, the number of dummy paths DP can be reduced.

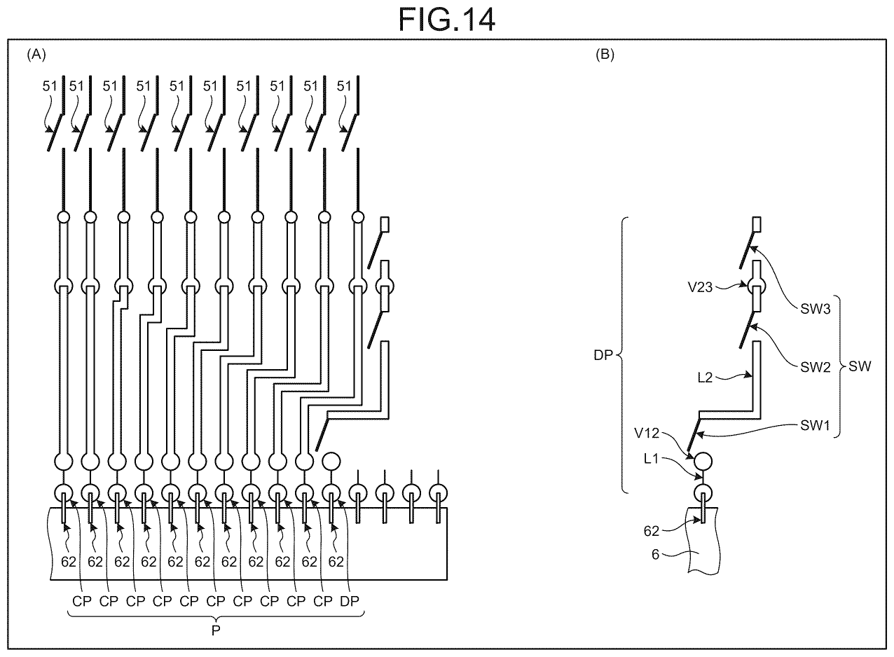

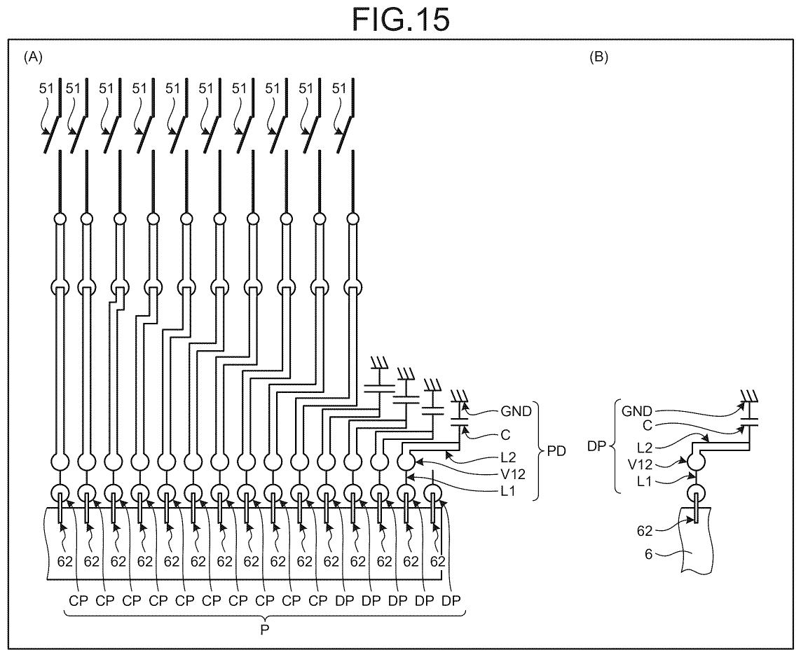

In the example illustrated in FIG. 15, the dummy path DP includes a capacitor C. The other end of the dummy path DP is connected to a ground GND via the capacitor C. The capacitor C is connected to the dummy path DP, whereby a capacitance when the dummy path DP is viewed from the output terminal 62 increases. By changing a capacitance of the capacitor C, it is possible to obtain the same effect as changing the length of the dummy path DP. The capacitor C is designed to have the same capacitance as a wiring capacitance of the wiring line L described above, for example. The capacitance of the capacitor C may be different so that the wiring capacitance is different for each dummy path DP. The wiring capacitance of the dummy path DP is implemented by the capacitor C, whereby the dummy path DP can be shortened.

In an embodiment, the defect of the connection path CP may be a short circuit. In that case, the other end of the dummy path DP may be short-circuited. In FIG. 11 described above, the consumption current I of the connection path CP in which the short circuit has occurred is larger than the consumption currents I of the other connection paths CP, whereby the connection path CP in which the short circuit has occurred is specified. The consumption current I of the dummy path DP is larger than the consumption current I of the connection path CP in which the short circuit has not occurred, and a short circuit portion of the connection path CP in which the short circuit has occurred can be specified by comparison with such a dummy path DP.

### 3. Examples of Effects

The technology described above is specified as follows, for example. One of the disclosed technologies is the display device 1. As described with reference to FIGS. 1, 3, and the like, the display device 1 includes the pixel array 3, the DDIC 6 (an example of the control unit), the plurality of selectors 51, and the plurality of paths P. The pixel array 3 includes the plurality of pixels 31. The DDIC 6 includes the plurality of output terminals 62 that outputs the video signals FS. Each of the plurality of selectors 51 is provided between the pixel array 3 and the DDIC 6 to electrically connect or electrically disconnect the corresponding output terminal 62 of the DDIC 6 and the corresponding pixel 31 of the pixel array 3. One end of each of the plurality of paths P is connected to the corresponding output terminal 62. The plurality of paths P includes: a plurality of connection paths CP connected to the selectors 51 corresponding to the other ends of the respective paths P; and a dummy path DP not connected to the selectors 51 corresponding to the other ends of the respective paths P. According to such a display device 1, for example, as described above with reference to FIGS. 10 to 12, and the like, a defective portion of the connection path CP between the output terminal 62 of the DDIC 6 and the switch 52 can be specified.

As described with reference to FIGS. 1, 3 to 9, and the like, the dummy path DP may be shorter than the connection path CP. The plurality of paths P may include a plurality of dummy paths DP having lengths different from each other. For example, the connection path CP may include the plurality of wiring lines L connected in series between the output terminal 62 and the selector 51, and the dummy path DP may include the smaller number of wiring lines L than the plurality of wiring lines L of the connection path CP. The adjacent wiring lines L among the plurality of wiring lines L may be connected to each other via the vias V to extend in the different wiring layers. The wiring line L located closest to the selector 51 in the dummy path DP may be shorter than the corresponding wiring line L of the connection path CP. The other end of the dummy path DP may be opened. For example, by using such a dummy path DP, it is possible to specify the disconnection portion of the connection path CP.

As described with reference to FIG. 13 and the like, at least some of the connection paths CP among the plurality of connection paths CP may include the switches SW connected in series in the connection paths CP, and at least some of the connection paths CP may be the dummy paths DP. As a result, the number of paths P can be reduced.

As described with reference to FIG. 14 and the like, the dummy path DP may include the switches SW connected in series in the dummy path DP. As a result, it is possible to cause one dummy path DP to function as a plurality of dummy paths DP having lengths different from each other. Accordingly, the number of dummy paths DP can be reduced.

As described with reference to FIG. 15 and the like, the other end of the dummy path DP may be connected to the ground GND via the capacitor C. The wiring capacitance of the dummy path DP is implemented by the capacitor C, whereby the dummy path DP can be shortened.

The analysis method described with reference to FIGS. 10 to 12, and the like is also one of the disclosed technologies. The analysis method is an analysis method for the display device 1 having the configuration described above, and includes: for each of the plurality of paths P, in a case where it is assumed that current loads of the respective output terminals 62 are equal to each other, outputting the video signals FS such that a current of the corresponding output terminal 62 is larger than currents of the other output terminals 62, and measuring the consumption current I of the DDIC 6 (step S1); and specifying the defective portion of at least one connection path CP among the plurality of connection paths CP on the basis of a result of the measuring (steps S2 to S3). For example, the specifying includes: specifying the connection path CP in which the consumption current I is small on the basis of the result of the measuring (step S2), and specifying, on the basis of the dummy path DP in which the consumption current I has the magnitude close to the magnitude of the consumption current I of the specified connection path CP, the disconnection portion of the connection path CP (step S3). By such an analysis method, it is possible to specify a defective portion of the connection path CP between the output terminal 62 of the DDIC 6 and the switch 52.

Note that the above-described effects are examples. There may be other effects.

### 4. Examples of Pixel Circuits

Some examples of the pixel circuit will be described with reference to FIGS. 16 to 23. Note that, in these figures, the pixel is indicated as a pixel PIX.

FIG. 16 is a diagram illustrating a configuration example of the pixel PIX. The pixel PIX includes a capacitor C01, transistors MN02 to MN03, and a light emitting element EL. The transistors MN02 to MN03 are N-type metal oxide semiconductor field effect transistors (MOSFETs). The gate of the transistor MN02 is connected to the control line WSL, the drain is connected to the signal line SGL, and the source is connected to the gate of the transistor MN03 and the capacitor C01. One end of the capacitor C01 is connected to the source of the transistor MN02 and the gate of the transistor MN03, and the other end is connected to the source of the transistor MN03 and the anode of the light emitting element EL. The gate of the transistor MN03 is connected to the source of the transistor MN02 and one end of the capacitor C01, the drain is connected to a power supply line VCCP, and the source is connected to the other end of the capacitor C01 and the anode of the light emitting element EL. The light emitting element EL is, for example, an organic EL light emitting element, the anode is connected to the source of the transistor MN03 and the other end of the capacitor C01, and the cathode is connected to a power supply line Vcath.

With this configuration, in the pixel PIX, the transistor MN02 enters the on state, whereby a voltage across the capacitor C01 is set on the basis of a pixel signal supplied from the signal line SGL. The transistor MN03 causes a current corresponding to the voltage across the capacitor C01 to flow through the light emitting element EL. The light emitting element EL emits light on the basis of the current supplied from the transistor MN03. In this manner, the pixel PIX emits light with luminance corresponding to the pixel signal.

FIG. 17 is a diagram illustrating another configuration example of the pixel PIX. The pixel PIX includes capacitors C11 and C12, transistors MP12 to MP15, and the light emitting element EL. The transistors MP12 to MP15 are P-type MOSFETs. The gate of the transistor MP12 is connected to the control line WSL, the source is connected to the signal line SGL, and the drain is connected to the gate of the transistor MP14 and the capacitor C12. One end of the capacitor C11 is connected to the power supply line VCCP, and the other end is connected to the capacitor C12, the drain of the transistor MP13, and the source of the transistor MP14. One end of the capacitor C12 is connected to the other end of the capacitor C11, the drain of the transistor MP13, and the source of the transistor MP14, and the other end is connected to the drain of the transistor MP12 and the gate of the transistor MP14. The gate of the transistor MP13 is connected to a control line DSL, the source is connected to the power supply line VCCP, and the drain is connected to the source of the transistor MP14, the other end of the capacitor C11, and one end of the capacitor C12. The gate of the transistor MP14 is connected to the drain of the transistor MP12 and the other end of the capacitor C12, the source is connected to the drain of the transistor MP13, the other end of the capacitor C11, and one end of the capacitor C12, and the drain is connected to the anode of the light emitting element EL and the source of the transistor MP15. The gate of the transistor MP15 is connected to a control line AZSL, the source is connected to the drain of the transistor MP14 and the anode of the light emitting element EL, and the drain is connected to a power supply line VSS.

With this configuration, in the pixel PIX, the transistor MP12 enters the on state, whereby a voltage across the capacitor C12 is set on the basis of a pixel signal supplied from the signal line SGL. The transistor MP13 is turned on and off on the basis of a signal of the control line DSL. The transistor MP14 causes a current corresponding to the voltage across the capacitor C12 to flow through the light emitting element EL during a period in which the transistor MP13 is in the on state. The light emitting element EL emits light on the basis of the current supplied from the transistor MP14. In this manner, the pixel PIX emits light with luminance corresponding to the pixel signal. The transistor MP15 is turned on and off on the basis of a signal of the control line AZSL. During a period in which the transistor MP15 is in the on state, a voltage of the anode of the light emitting element EL is initialized by being set to a voltage of the power supply line VSS.

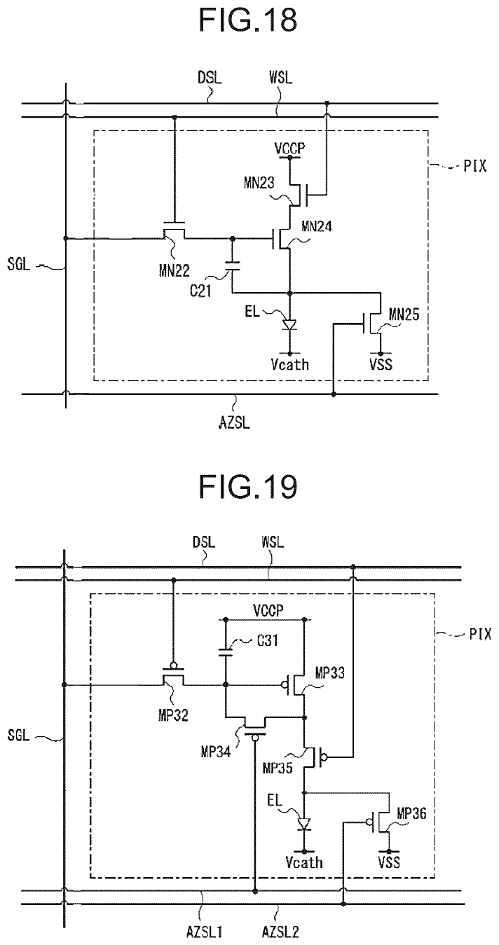

FIG. 18 is a diagram illustrating another configuration example of the pixel PIX. The pixel PIX includes a capacitor C21, transistors MN22 to MN25, and the light emitting element EL. The transistors MN22 to MN25 are N-type MOSFETs. The gate of the transistor MN22 is connected to the control line WSL, the drain is connected to the signal line SGL, and the source is connected to the gate of the transistor MN24 and the capacitor C21. One end of the capacitor C21 is connected to the source of the transistor MN22 and the gate of the transistor MN24, and the other end is connected to the source of the transistor MN24, the drain of the transistor MN25, and the anode of the light emitting element EL. The gate of the transistor MN23 is connected to the control line DSL, the drain is connected to the power supply line VCCP, and the source is connected to the drain of the transistor MN24. The gate of the transistor MN24 is connected to the source of the transistor MN22 and one end of the capacitor C21, the drain is connected to the source of the transistor MN23, and the source is connected to the other end of the capacitor C21, the drain of the transistor MN25, and the anode of the light emitting element EL. The gate of the transistor MN25 is connected to the control line AZSL, the drain is connected to the source of the transistor MN24, the other end of the capacitor C21, and the anode of the light emitting element EL, and the source is connected to the power supply line VSS.

With this configuration, in the pixel PIX, the transistor MN22 enters the on state, whereby a voltage across the capacitor C21 is set on the basis of a pixel signal supplied from the signal line SGL. The transistor MN23 is turned on and off on the basis of a signal of the control line DSL. The transistor MN24 causes a current corresponding to the voltage across the capacitor C21 to flow through the light emitting element EL during a period in which the transistor MN23 is in the on state. The light emitting element EL emits light on the basis of the current supplied from the transistor MN24. In this manner, the pixel PIX emits light with luminance corresponding to the pixel signal. The transistor MN25 is turned on and off on the basis of a signal of the control line AZSL. During a period in which the transistor MN25 is in the on state, the voltage of the anode of the light emitting element EL is initialized by being set to the voltage of the power supply line VSS.

FIG. 19 is a diagram illustrating another configuration example of the pixel PIX. The pixel PIX includes a capacitor C31, transistors MP32 to MP36, and the light emitting element EL. The transistors MP32 to MP36 are P-type MOSFETs. The gate of the transistor MP32 is connected to the control line WSL, the source is connected to the signal line SGL, and the drain is connected to the gate of the transistor MP33, the drain of the transistor MP34, and the capacitor C31. One end of the capacitor C31 is connected to the power supply line VCCP, and the other end is connected to the drain of the transistor MP32, the gate of the transistor MP33, and the drain of the transistor MP34. The gate of the transistor MP34 is connected to a control line AZSL 1, the source is connected to the drain of the transistor MP33 and the source of the transistor MP35, and the drain is connected to the drain of the transistor MP32, the gate of the transistor MP33, and the other end of the capacitor C31. The gate of the transistor MP35 is connected to the control line DSL, the source is connected to the drain of the transistor MP33 and the source of the transistor MP34, and the drain is connected to the source of the transistor MP36 and the anode of the light emitting element EL. The gate of the transistor MP36 is connected to a control line AZSL2, the source is connected to the drain of the transistor MP35 and the anode of the light emitting element EL, and the drain is connected to the power supply line VSS.

With this configuration, in the pixel PIX, the transistor MP32 enters the on state, whereby a voltage across the capacitor C31 is set on the basis of a pixel signal supplied from the signal line SGL. The transistor MP35 is turned on and off on the basis of a signal of the control line DSL. The transistor MP33 causes a current corresponding to the voltage across the capacitor C31 to flow through the light emitting element EL during a period in which the transistor MP35 is in the on state. The light emitting element EL emits light on the basis of the current supplied from the transistor MP33. In this manner, the pixel PIX emits light with luminance corresponding to the pixel signal. The transistor MP34 is turned on and off on the basis of a signal of the control line AZSL1. During a period in which the transistor MP34 is in the on state, the drain and the gate of the transistor MP33 are connected to each other. The transistor MP36 is turned on and off on the basis of a signal of the control line AZSL2. During a period in which the transistor MP36 enters the on state, the voltage of the anode of the light emitting element EL is initialized by being set to the voltage of the power supply line VSS.

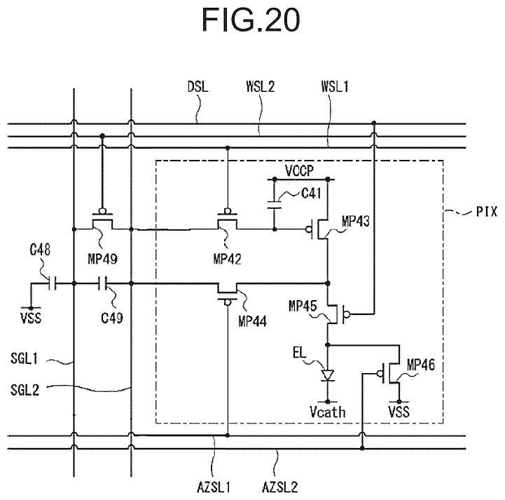

FIG. 20 is a diagram illustrating another configuration example of the pixel PIX. One end of a capacitor C48 is connected to a signal line SGL1, and the other end is connected to the power supply line VSS. One end of a capacitor C49 is connected to the signal line SGL1, and the other end is connected to a signal line SGL2. A transistor MP49 is a P-type MOSFET, and the gate is connected to a control line WSL2, the source is connected to the signal line SGL1, and the drain is connected to the signal line SGL2.

The pixel PIX includes a capacitor C41, transistors MP42 to MP46, and the light emitting element EL. The transistors MP42 to MP46 are P-type MOSFETs. The gate of the transistor MP42 is connected to a control line WSL1, the source is connected to the signal line SGL2, and the drain is connected to the gate of the transistor MP43 and the capacitor C41. One end of the capacitor 41 is connected to the power supply line VCCP, and the other end is connected to the drain of the transistor MP42 and the gate of the transistor MP43. The gate of the transistor MP43 is connected to the drain of the transistor MP42 and the other end of the capacitor C41, the source is connected to the power supply line VCCP, and the drain is connected to the sources of the transistors MP44 and MP45. The gate of the transistor MP44 is connected to the control line AZSL1, the source is connected to the drain of the transistor MP43 and the source of the transistor MP45, and the drain is connected to the signal line SGL2. The gate of the transistor MP45 is connected to the control line DSL, the source is connected to the drain of the transistor MP43 and the source of the transistor MP44, and the drain is connected to the source of the transistor MP46 and the anode of the light emitting element EL. The gate of the transistor MP46 is connected to the control line AZSL2, the source is connected to the drain of the transistor MP45 and the anode of the light emitting element EL, and the drain is connected to the power supply line VSS.

With this configuration, in the pixel PIX, the transistor MP42 enters the on state, whereby a voltage across the capacitor C41 is set on the basis of the pixel signal supplied from the signal line SGL1 via the capacitor C49. The transistor MP45 is turned on and off on the basis of a signal of the control line DSL. The transistor MP43 causes a current corresponding to the voltage across the capacitor C41 to flow through the light emitting element EL during a period in which the transistor MP45 is in the on state. The light emitting element EL emits light on the basis of the current supplied from the transistor MP43. In this manner, the pixel PIX emits light with luminance corresponding to the pixel signal. The transistor MP44 is turned on and off on the basis of a signal of the control line AZSL1. During a period in which the transistor MP44 is in the on state, the drain of the transistor MP43 and the signal line SGL2 are connected to each other. The transistor MP46 is turned on and off on the basis of a signal of the control line AZSL2. During a period in which the transistor MP46 enters the on state, the voltage of the anode of the light emitting element EL is initialized by being set to the voltage of the power supply line VSS.

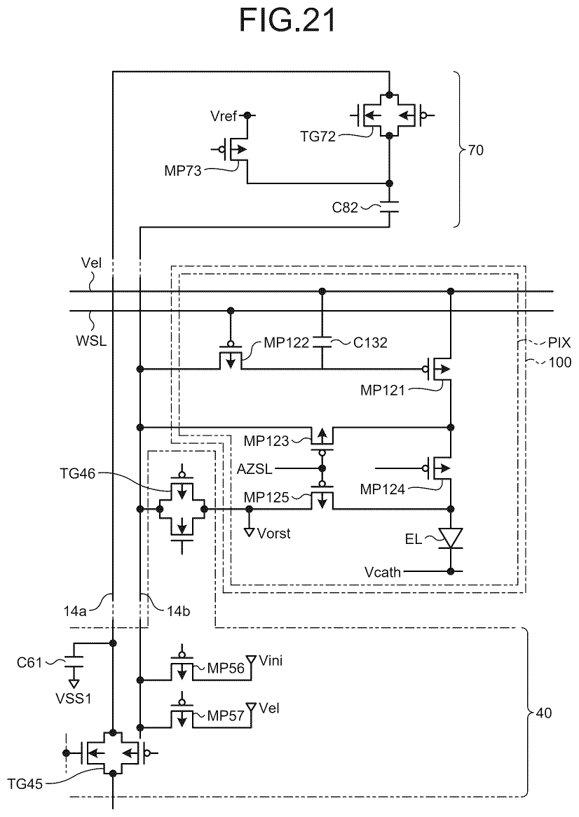

FIG. 21 is a diagram illustrating another configuration example of the pixel PIX. A plurality of pixels PIX is provided in a matrix in a display area 100, and the display area 100 is provided between a first control unit 40 and a second control unit 70.

The first control unit 40 includes transmission gates TG45 and TG46, transistors MP56 and MP57, and a capacitor C61. The transistors MP56 to MP57 are P-type MOSFETs. A pixel signal is supplied to an input end of the transmission gate TG45, and an output end of the transmission gate TG45 is connected to one end of a signal line 14a. An input end of the transmission gate TG46 is connected to a signal line 14b, and an output end of the transmission gate TG46 is connected to a power supply line Vorst. One end of the capacitor C61 is connected to the signal line 14a, and the other end is connected to a power supply line VSS1. The gate of the transistor MP56 is connected to a control line, the source is connected to a power supply line Vini, and the drain is connected to the signal line 14b. The gate of the transistor MP57 is connected to a control line, the source is connected to a power supply line Ve1, and the drain is connected to the signal line 14b.

The second control unit 70 includes a transmission gate TG72, a transistor MP73, and a capacitor C82. The transistor MP73 is a P-type MOSFET. An input end of the transmission gate TG72 is connected to the other end of the signal line 14a, and an output end is connected to the drain of the transistor MP73 and one end of the capacitor C82. The gate of the transistor MP73 is connected to a control line, the source is connected to a power supply line Vref, and the drain is connected to an output end of the transmission gate MP72 and one end of the capacitor C82. One end of the capacitor C82 is connected to the output end of the transmission gate TG72 and the drain of the transistor MP73, and the other end is connected to one end of the signal line 14b.

The pixel PIX includes a capacitor C132, transistors MP121 to MP125, and the light emitting element EL. The transistors MP121 to MP125 are P-type MOSFETs. The gate of the transistor MP122 is connected to the control line WSL, the source is connected to the signal line 14b, and the drain is connected to the gate of the transistor MP121 and the capacitor C132. One end of the capacitor C132 is connected to the power supply line Ve1, and the other end is connected to the drain of the transistor MP122 and the gate of the transistor MP121. The gate of the transistor MP121 is connected to the drain of the transistor MP122 and the other end of the capacitor C132, the source is connected to the power supply line Ve1, and the drain is connected to the sources of the transistors MP123 and MP124. The gate of the transistor MP123 is connected to the control line AZSL, the source is connected to the drain of the transistor MP121 and the source of the transistor MP124, and the drain is connected to the signal line 14b. The gate of the transistor MP124 is connected to a control line, the source is connected to the drain of the transistor MP121 and the source of the transistor MP123, and the drain is connected to the drain of the transistor MP125 and the anode of the light emitting element EL. The gate of the transistor MP125 is connected to the control line AZSL, the source is connected to the power supply line Vorst, and the drain is connected to the drain of the transistor MP124 and the anode of the light emitting element EL.

With this configuration, in the pixel PIX, the transistor MP122 enters the on state, whereby a voltage across the capacitor C132 is set on the basis of a pixel signal supplied via the transmission gate TG45, the signal line 14a, the transmission gate TG72, the capacitor C82, and the signal line 14b. The transistor MP124 is turned on and off on the basis of a signal of the control line. The transistor MP121 causes a current corresponding to the voltage across the capacitor C132 to flow through the light emitting element EL during a period in which the transistor MP124 is in the on state. The light emitting element EL emits light on the basis of the current supplied from the transistor MP121. In this manner, the pixel PIX emits light with luminance corresponding to the pixel signal. The transistors MP123 and MP125 are turned on and off on the basis of a signal of the control line AZSL. During a period in which the transistor MP123 is in the on state, the drain of the transistor MP121 and the source of the transistor MP124 are connected to the signal line 14b. During a period in which the transistor MP125 enters the on state, the voltage of the anode of the light emitting element EL is initialized by being set to the voltage of the power supply line Vorst. Furthermore, the transistor MP56 is turned on and off on the basis of a signal of the control line, the transistor MP57 is turned on and off on the basis of a signal of the control line, and the transistor MP73 is turned on and off on the basis of a signal of the control line. When the transistor MP56 enters the on sate, the signal line 14b is set to a voltage of the power supply line Vini, and when the transistor MP57 enters the on state, the signal line 14b is set to a voltage of the power supply line Ve1. When the transistor MP73 enters the on state, one end of the capacitor C82 is initialized by being set to a voltage of the power supply line Vref.

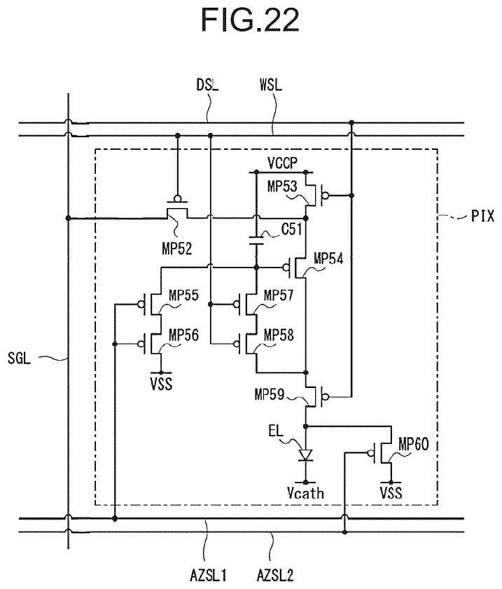

FIG. 22 is a diagram illustrating another configuration example of the pixel PIX. The pixel PIX includes a capacitor C51, transistors MP52 to MP60, and the light emitting element EL. The transistors MP52 to MP60 are P-type MOSFETs. The gate of the transistor MP52 is connected to the control line WSL, the source is connected to the signal line SGL, and the drain is connected to the drain of the transistor MP53 and the source of the transistor MP54. The gate of the transistor MP53 is connected to the control line DSL, the source is connected to the power supply line VCCP, and the drain is connected to the drain of the transistor MP52 and the source of the transistor MP54. The gate of the transistor MP54 is connected to the source of the transistor MP55, the drain of the transistor MP57, and the capacitor C51, the source is connected to the drains of the transistors MP52 and MP53, and the drain is connected to the sources of the transistors MP58 and MP59. One end of the capacitor C51 is connected to the power supply line VCCP, and the other end is connected to the gate of the transistor MP54, the source of the transistor MP55, and the drain of the transistor MP57. The capacitor C51 may include two capacitors connected in parallel to each other. The gate of the transistor MP55 is connected to the control line AZSL1, the source is connected to the gate of the transistor MP54, the drain of the transistor MP57, and the other end of the capacitor C51, and the drain is connected to the source of the transistor MP56. The gate of the transistor MP56 is connected to the control line AZSL1, the source is connected to the drain of the transistor MP55, and the drain is connected to the power supply line VSS. The gate of the transistor MP57 is connected to the control line WSL, the drain is connected to the gate of the transistor MP54, the source of the transistor MP55, and the other end of the capacitor C51, and the source is connected to the drain of the transistor MP58. The gate of the transistor MP58 is connected to the control line WSL, the drain is connected to the source of the transistor MP57, and the source is connected to the drain of the transistor MP54 and the source of the transistor MP59. The gate of the transistor 59 is connected to the control line DSL, the source is connected to the drain of the transistor MP54 and the source of the transistor MP58, and the drain is connected to the source of the transistor MP60 and the anode of the light emitting element EL. The gate of the transistor MP60 is connected to the control line AZSL2, the source is connected to the drain of the transistor MP59 and the anode of the light emitting element EL, and the drain is connected to the power supply line VSS.

With this configuration, in the pixel PIX, the transistors MP52, MP54, MP58, and MP57 enter the on states, whereby a voltage across the capacitor C51 is set on the basis of a pixel signal supplied from the signal line SGL. The transistors MP53 and MP59 are turned on and off on the basis of a signal of the control line DSL. The transistor MP54 causes a current corresponding to the voltage across the capacitor C51 to flow through the light emitting element EL during a period in which the transistors MP53 and MP59 are in the on states. The light emitting element EL emits light on the basis of the current supplied from the transistor MP54. In this manner, the pixel PIX emits light with luminance corresponding to the pixel signal. The transistors MP55 and MP56 are turned on and off on the basis of a signal of the control line AZSL1. During a period in which the transistors MP55 and MP56 are in the on-state, a voltage of the gate of the transistor MP54 is initialized by being set to the voltage of the power supply line VSS. The transistor MP60 is turned on and off on the basis of a signal of the control line AZSL2. During a period in which the transistor MP60 is in the on state, the voltage of the anode of the light emitting element EL is initialized by being set to the voltage of the power supply line VSS.

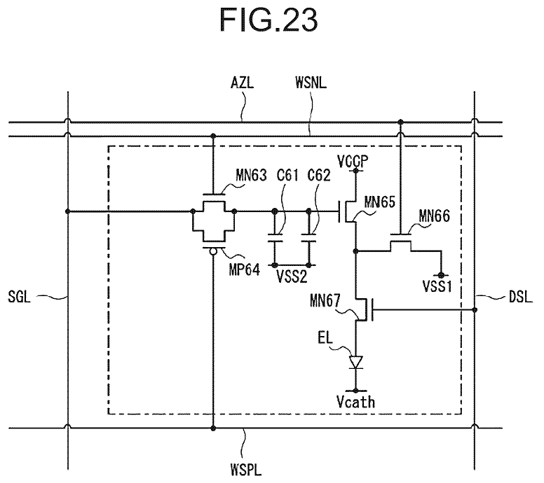

FIG. 23 is a diagram illustrating another configuration example of the pixel PIX. A signal of a control line WSNL and a signal of a control line WSPL are signals inverted from each other.

The pixel PIX includes capacitors C61 and C62, transistors MN63, MP64, and MN65 to MN67, and the light emitting element EL. The transistors MN63 and MN65 to MN67 are N-type MOSFETs, and the transistor MP64 is a P-type MOSFET. The gate of the transistor MN63 is connected to the control line WSNL, the drain is connected to the signal line SGL and the source of the transistor MP64, and the source is connected to the drain of the transistor MP64, the capacitors C61 and C62, and the gate of the transistor MN65. The gate of the transistor MP64 is connected to the control line WSPL, the source is connected to the signal line SGL and the drain of the transistor MN63, and the drain is connected to the source of the transistor MN63, the capacitors C61 and C62, and the gate of the transistor MN65. The capacitor C61 includes, for example, a metal oxide metal (MOM) capacitor, and one end is connected to the source of the transistor MN63, the drain of the transistor MP64, the capacitor C62, and the gate of the transistor MN65, and the other end is connected to a power supply line VSS2. Note that the capacitor C61 may include, for example, a MOS capacitor or a metal insulator metal (MIM) capacitor. The capacitor C62 includes, for example, a MOS capacitor, and one end is connected to the source of the transistor MN63, the drain of the transistor MP64, one end of the capacitor C61, and the gate of the transistor MN65, and the other end is connected to the power supply line VSS2. Note that the capacitor C62 may include, for example, an MOM capacitor or an MIM capacitor. The gate of the transistor MN65 is connected to the source of the transistor MN63, the drain of the transistor MP64, and one ends of the capacitors C61 and C62, the drain is connected to the power supply line VCCP, and the source is connected to the drains of the transistors MN66 and MN67. The gate of the transistor MN66 is connected to a control line AZL, the drain is connected to the source of the transistor MN65 and the drain of the transistor MN67, and the source is connected to the power supply line VSS1. The gate of the transistor MN67 is connected to the control line DSL, the drain is connected to the source of the transistor MN65 and the drain of the transistor MN66, and the source is connected to the anode of the light emitting element EL.

With this configuration, in the pixel PIX, at least one of the transistors MN63 and MP64 enters the on state, whereby a voltage across the capacitors C61 and C62 is set on the basis of a pixel signal supplied from the signal line SGL. The transistor MN67 is turned on and off on the basis of a signal of the control line DSL. The transistor MN65 causes a current corresponding to the voltage across the capacitors C61 and C62 to flow through the light emitting element EL during a period in which the transistor MN67 is in the on state. The light emitting element EL emits light on the basis of the current supplied from the transistor MP65. In this manner, the pixel PIX emits light with luminance corresponding to the pixel signal. The transistor MN66 may be turned on and off on the basis of a signal of the control line AZL. Furthermore, the transistor MN66 may function as a resistance element having a resistance value corresponding to the signal of the control line AZL. In this case, the transistor MN65 and the transistor MN66 constitute a so-called source follower circuit.

### 5. Examples of Use Cases

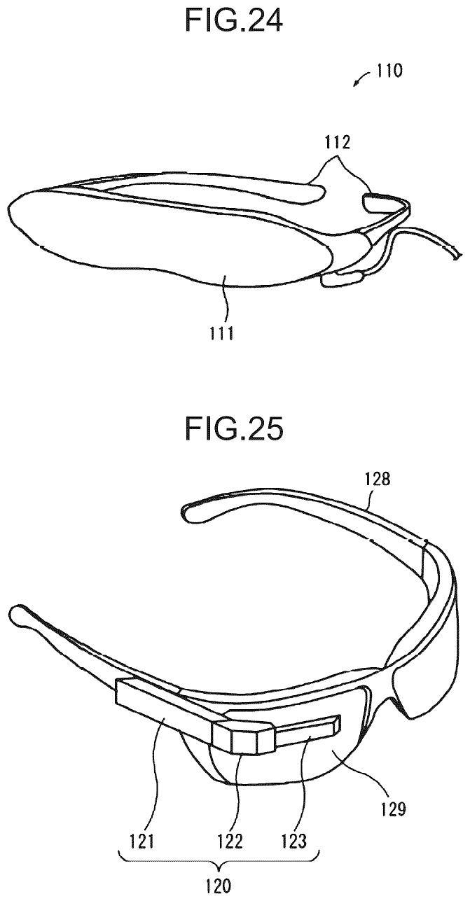

Examples of some use cases (applications) of the display device 1 will be described with reference to FIGS. 24 to 31.

### Application Example 1

FIG. 24 is a diagram illustrating an example of an external appearance of a head mounted display 110. The head mounted display 110 includes, for example, ear hooking portions 112 to be worn on the head of a user on both sides of a glasses-shaped display unit 111. The technology according to the above embodiment and the like can be applied to such a head mounted display 110.

### Application Example 2

FIG. 25 is a diagram illustrating an example of an external appearance of another head mounted display 120. The head mounted display 120 is a transmissive head mounted display including a main body portion 121, an arm portion 122, and a lens barrel portion 123. The head mounted display 120 is mounted on glasses 128. The main body portion 121 includes a control board and a display unit for controlling operation of the head mounted display 120. The display unit emits image light of a display image. The arm portion 122 connects the main body portion 121 and the lens barrel portion 123 together and supports the lens barrel portion 123. The lens barrel portion 123 projects image light supplied from the main body portion 121 via the arm portion 122 toward user's eyes via a lens 129 of the glasses 128. The technology according to the above embodiment and the like can be applied to such a head mounted display 120.

Note that the head mounted display 120 is a so-called light guide plate type head mounted display, but is not limited thereto, and may be, for example, a so-called birdbath type head mounted display. The birdbath type head mounted display includes, for example, a beam splitter and a partially transparent mirror. The beam splitter outputs light encoded with image information toward the mirror, and the mirror reflects the light toward the user's eyes. Both the beam splitter and the partially transparent mirror are partially transparent. As a result, light from a surrounding environment reaches the user's eyes.

### Application Example 3

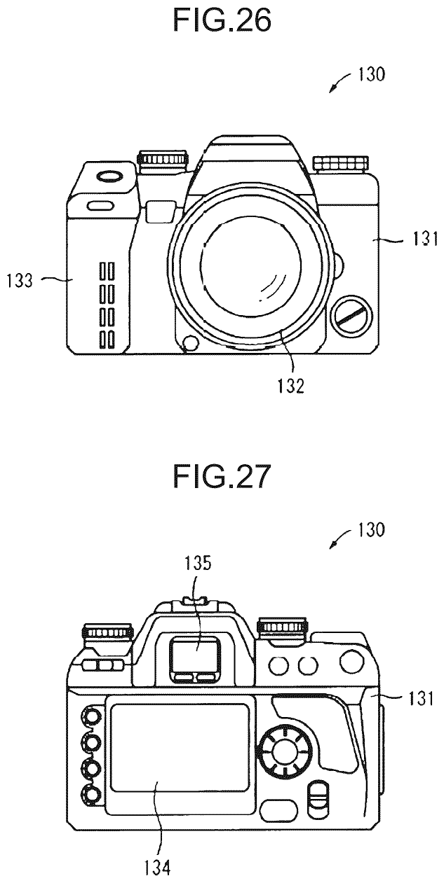

FIGS. 26 and 27 are diagrams illustrating an example of an external appearance of a digital still camera 130. FIG. 26 illustrates a front view and FIG. 27 illustrates a rear view. The digital still camera 130 is a lens interchangeable single lens reflex type camera, and includes a camera body portion (camera body) 131, an imaging lens unit 132, a grip portion 133, a monitor 134, and an electronic viewfinder 135. The imaging lens unit 312 is an interchangeable lens unit, and is provided near substantially the center of the front of the camera body portion 311. The grip portion 133 is provided on the left side of the front surface of the camera body portion 311, and a photographer grips the grip portion 133. The monitor 134 is provided on the left side of substantially the center of the rear of the camera body portion 131. The electronic viewfinder 135 is provided on the upper part of the monitor 14 on the rear of the camera body portion 131. By looking into the electronic viewfinder 135, the photographer can visually recognize an optical image of a subject guided from the imaging lens unit 132 and determine a composition. The technology according to the above embodiment and the like can be applied to the electronic viewfinder 135.

### Application Example 4

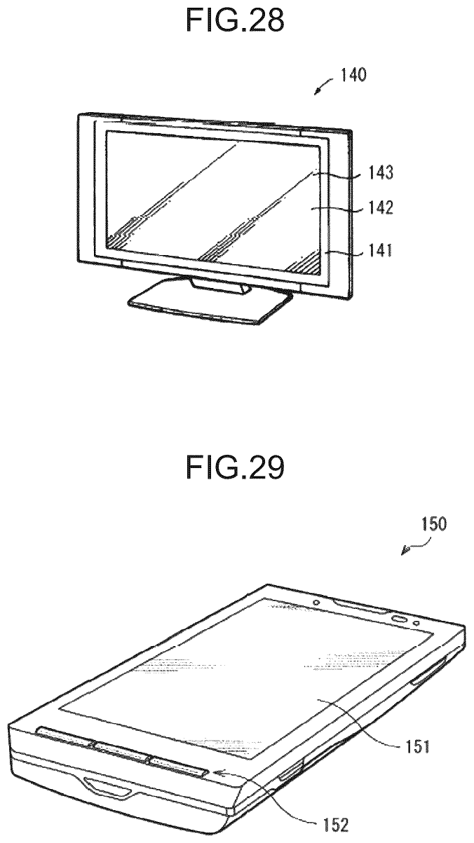

FIG. 28 is a diagram illustrating an example of an external appearance of a television device 140. The television device 140 includes a video display screen unit 141 including a front panel 142 and a filter glass 143. The technology according to the above embodiment and the like can be applied to the video display screen unit 141.

### Application Example 5

FIG. 29 is a diagram illustrating an example of an external appearance of a smartphone 150. The smartphone 150 includes a display unit 151 that displays various types of information, and an operation unit 152 including a button or the like that receives operation input by the user. The technology according to the above embodiment and the like can be applied to the display unit 151.

### Application Example 6

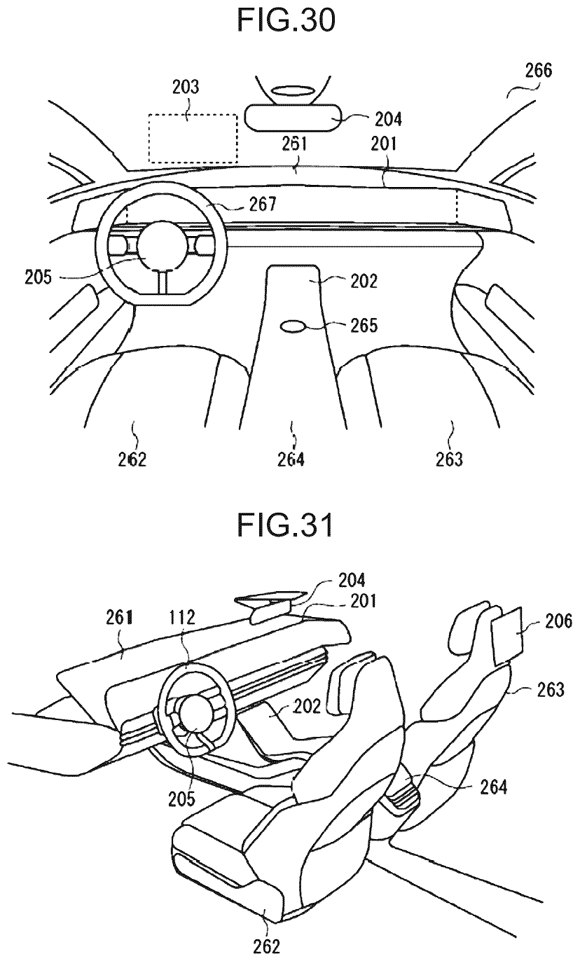

FIGS. 30 and 31 are diagrams illustrating a configuration example of a vehicle to which the technology of the present disclosure is applied. FIG. 30 illustrates an example of the interior of the vehicle as viewed from the rear of the vehicle, and FIG. 31 illustrates an example of the interior of the vehicle as viewed from the left rear of the vehicle.

The vehicle of FIGS. 30 and 31 includes a center display 201, a console display 202, a head-up display 203, a digital rear mirror 204, a steering wheel display 205, and a rear entertainment display 106.

The center display 201 is disposed on a dashboard 261 at a position facing a driver's seat 262 and a passenger seat 263. In the figure, an example is illustrated of the center display 201 having a horizontally long shape extending from the driver's seat 262 side to the passenger seat 263 side, but a screen size and an arrangement place of the center display 201 are not limited thereto. The center display 201 can display information detected by various sensors. As a specific example, the center display 201 can display a captured image captured by an image sensor, a distance image to an obstacle in front of or on a side of the vehicle measured by a ToF sensor, a body temperature of an occupant detected by an infrared sensor, and the like. The center display 201 can be used to display, for example, at least one of safety related information, operation related information, a life log, health related information, authentication/identification related information, or entertainment related information.

The safety related information is information on doze detection, looking-away detection, detection of mischief of a child riding together, presence or absence of wearing a seat belt, detection of leaving of an occupant, and the like based on a sensor detection result. The operation related information is information on gesture regarding operation by an occupant detected by using a sensor. The gesture may include operation on various facilities in the vehicle, for example, operation on an air conditioning facility, a navigation device, an audio visual (AV) device, a lighting device, and the like. The life log includes life logs of all occupants. For example, the life log includes an action record of each occupant. By acquiring and storing the life log, it is possible to confirm a state of the occupant when an accident occurs. The health related information includes the body temperature of the occupant detected by using a temperature sensor and information on a health condition of the occupant estimated on the basis of the detected body temperature. Alternatively, the information on the health condition of the occupant may be estimated on the basis of the face of the occupant imaged by the image sensor. Furthermore, the information on the health condition of the occupant may be estimated on the basis of the content of the occupant's answer obtained by having a conversation with the occupant by using an automatic voice. The authentication/identification related information includes information on a keyless entry function for performing face authentication by using a sensor, an automatic adjustment function for the seat height and position by face identification, and the like. The entertainment related information includes operation information on the AV device by the occupant detected by a sensor, information on a content to be displayed suitable for the occupant detected and recognized by the sensor, and the like.

The console display 202 can be used to display life log information, for example. The console display 202 is disposed near a shift lever 265 in a center console 264 between the driver's seat 262 and the passenger seat 263. The console display 202 can also display information detected by various sensors. Furthermore, the console display 202 may display an image of the periphery of the vehicle captured by the image sensor, or may display a distance image to an obstacle in the periphery of the vehicle.

The head-up display 203 is virtually displayed behind a windshield 266 in front of driver's seat 262. The head-up display 203 can be used to display, for example, at least one of safety related information, operation related information, a life log, health related information, authentication/identification related information, or entertainment related information. Since the head-up display 203 is often virtually disposed in front of the driver's seat 262, it is suitable for displaying information directly related to operation on the vehicle, such as a speed of the vehicle, a remaining amount of fuel, and a remaining amount of a battery.

The digital rear mirror 204 can display not only the rear of the vehicle but also a state of the occupant in a back seat, and thus can be used to display the life log information on the occupant in the back seat, for example.

The steering wheel display 205 is disposed near the center of a steering wheel 267 of the vehicle. The steering wheel display 205 can be used to display, for example, at least one of safety related information, operation related information, a life log, health related information, authentication/identification related information, or entertainment related information. In particular, the steering wheel display 205 is close to a driver's hand, and thus, is suitable for displaying the life log information such as the body temperature of the driver, or for displaying information regarding the operation on the AV device, the air conditioning facility, or the like.

The rear entertainment display 206 is attached to the back side of the driver's seat 262 and the passenger seat 263, and is for viewing by an occupant in the back seat. The rear entertainment display 206 can be used to display, for example, at least one of safety related information, operation related information, a life log, health related information, authentication/identification related information, or entertainment related information. In particular, since the rear entertainment display 206 is in front of the occupant in the back seat, information related to the occupant in the back seat is displayed. The rear entertainment display 206 may display, for example, information regarding the operation on the AV device or the air conditioning facility, or may display a result of measuring the body temperature or the like of the occupant in the back seat by the temperature sensor.

The technology according to the above embodiment and the like can be applied to the center display 201, the console display 202, the head-up display 203, the digital rear mirror 204, the steering wheel display 205, and the rear entertainment display 206.

Note that the effects described in the present disclosure are merely examples and are not limited to the disclosed contents. There may be other effects.

Although the embodiments of the present disclosure have been described above, the technical scope of the present disclosure is not limited to the above-described embodiments as they are, and various modifications can be made without departing from the gist of the present disclosure. Furthermore, components of different embodiments and modifications may be appropriately combined.

Note that, the present technology can also have the following configurations.
(1) A display device comprising:

a pixel array including a plurality of pixels;

a control unit including a plurality of output terminals that outputs video signals;

a plurality of selectors provided between the pixel array and the control unit, each selector electrically connecting or electrically disconnecting a corresponding output terminal of the control unit and a corresponding pixel of the pixel array to or from each other; and

a plurality of paths connected to the output terminals corresponding to one ends of the respective paths, wherein

the plurality of paths includes:

a plurality of connection paths connected to the selectors corresponding to another ends of the respective paths; and

a dummy path not connected to the selectors corresponding to another ends of the respective path.
(2) The display device according to (1), wherein

the dummy path is shorter than the connection paths.
(3) The display device according to (1) or (2), wherein

the plurality of paths includes a plurality of the dummy paths having lengths different from each other.
(4) The display device according to any one of (1) to (3), wherein

the connection paths include a plurality of wiring lines connected in series between the output terminals and the selectors, and

the dummy path includes a smaller number of wiring lines than the plurality of wiring lines of the connection paths.
(5) The display device according to (4), wherein

adjacent wiring lines among the plurality of wiring lines are connected to each other via a via to extend in different wiring layers.
(6) The display device according to (4) or (5), wherein

a wiring line located closest to the selectors in the dummy path is shorter than a corresponding wiring line of the connection paths.
(7) The display device according to any one of (1) to (6), wherein

at least some connection path among the plurality of connection paths include switches connected in series in the at least some connection paths, and

the at least some connection paths each are also the dummy path.
(8) The display device according to any one of (1) to (7), wherein

the dummy path includes switches connected in series in the dummy path.
(9) The display device according to any one of (1) to (8), wherein

another end of the dummy path is opened.
(10) The display device according to any one of (1) to (9), wherein

another end of the dummy path is connected to ground via a capacitor.
(11) An analysis method for a display device,

the display device including:

a pixel array including a plurality of pixels;

a control unit including a plurality of output terminals that outputs video signals;

a plurality of selectors provided between the pixel array and the control unit, each selector electrically connecting or electrically disconnecting a corresponding output terminal of the control unit and a corresponding pixel of the pixel array to or from each other; and

a plurality of paths connected to the output terminals corresponding to one ends of the respective paths,

the plurality of paths including:

a plurality of connection paths connected to the selectors corresponding to another ends of the respective paths; and

a dummy path not connected to the selectors corresponding to another ends of the respective path,

the analysis method comprising:

for each of the plurality of paths, in a case where it is assumed that current loads of the respective output terminals are equal to each other, outputting the video signals such that a current of a corresponding one of the output terminals is larger than a current of another of the output terminals, and measuring a consumption current of the control unit; and

specifying a defective portion of at least one connection path among the plurality of connection paths on a basis of a result of the measuring.
(12) The analysis method according to (11), wherein

the specifying includes:

specifying a connection path in which the consumption current is small on the basis of the result of the measuring; and

specifying, on a basis of the dummy path in which a consumption current has a magnitude close to a magnitude of the consumption current of the specified connection path, a disconnection portion of the connection path.

### REFERENCE SIGNS LIST

DISPLAY DEVICE
2 DISPLAY PANEL
21 POWER SUPPLY
3 PIXEL ARRAY
31 PIXEL
4 VERTICAL DRIVER
5 HORIZONTAL DRIVER
51 SELECTOR
52 SWITCH
6 DDIC (CONTROL UNIT)
61 AMPLIFIER
62 OUTPUT TERMINAL
P PATH
CP CONNECTION PATH
DP DUMMY PATH
L WIRING LINE
SG PIXEL SIGNAL
SGL SIGNAL LINE
SW SWITCH
V VIA
WS CONTROL SIGNAL
WSL CONTROL LINE

What is claimed is:

1. A display device, comprising:
a pixel array including a plurality of pixels;
a control unit including a plurality of output terminals that outputs video signals;
a plurality of selectors provided between the pixel array and the control unit, each selector electrically connecting or electrically disconnecting a corresponding output terminal of the control unit and a corresponding pixel of the pixel array to or from each other; and
a plurality of paths connected to the output terminals corresponding to one ends of the respective paths, wherein
the plurality of paths includes:
a plurality of connection paths connected to the selectors corresponding to another ends of the respective paths; and
a dummy path not connected to the selectors corresponding to another ends of the respective path.

2. The display device according to claim 1, wherein
the dummy path is shorter than the connection paths.

3. The display device according to claim 1, wherein
the plurality of paths includes a plurality of the dummy paths having lengths different from each other.

4. The display device according to claim 1, wherein
the connection paths include a plurality of wiring lines connected in series between the output terminals and the selectors, and
the dummy path includes a smaller number of wiring lines than the plurality of wiring lines of the connection paths.

5. The display device according to claim 4, wherein
adjacent wiring lines among the plurality of wiring lines are connected to each other via a via to extend in different wiring layers.

6. The display device according to claim 4, wherein
a wiring line located closest to the selectors in the dummy path is shorter than a corresponding wiring line of the connection paths.

7. The display device according to claim 1, wherein
at least some connection path among the plurality of connection paths include switches connected in series in the at least some connection paths, and
the at least some connection paths each are also the dummy path.

8. The display device according to claim 1, wherein
the dummy path includes switches connected in series in the dummy path.

9. The display device according to claim 1, wherein
another end of the dummy path is opened.

10. The display device according to claim 1, wherein
another end of the dummy path is connected to ground via a capacitor.

11. An analysis method for a display device,
the display device including:
a pixel array including a plurality of pixels;
a control unit including a plurality of output terminals that outputs video signals;
a plurality of selectors provided between the pixel array and the control unit, each selector electrically connecting or electrically disconnecting a corresponding output terminal of the control unit and a corresponding pixel of the pixel array to or from each other; and
a plurality of paths connected to the output terminals corresponding to one ends of the respective paths,
the plurality of paths including:
a plurality of connection paths connected to the selectors corresponding to another ends of the respective paths; and
a dummy path not connected to the selectors corresponding to another ends of the respective path,
the analysis method comprising:
for each of the plurality of paths, in a case where it is assumed that current loads of the respective output terminals are equal to each other, outputting the video signals such that a current of a corresponding one of the output terminals is larger than a current of another of the output terminals, and measuring a consumption current of the control unit; and
specifying a defective portion of at least one connection path among the plurality of connection paths on a basis of a result of the measuring.

12. The analysis method according to claim 11, wherein
the specifying includes:
specifying a connection path in which the consumption current is small on the basis of the result of the measuring; and
specifying, on a basis of the dummy path in which a consumption current has a magnitude close to a magnitude of the consumption current of the specified connection path, a disconnection portion of the connection path.
